(19) United States
(12) Patent Application Publication
(10) Pub. No.: US 2008/0268932 A1
(43) Pub. Date: Oct. 30, 2008

(54) GAMING MACHINE WITH A PLURALITY OF TOUCH PANELS AS AN INPUT DEVICE

(75) Inventor: Hiroyuki Nagano, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: Aruze Corp., Tokyo (JP)

(21) Appl. No.: 12/099,419

(22) Filed: Apr. 8, 2008

(30) Foreign Application Priority Data
Apr. 26, 2007 (JP) 2007-117330

(51) Int. Cl. A63F 13/00

(52) U.S. Cl. 463/11

(57) ABSTRACT

A gaming machine includes a display device, a plurality of input devices, and a controller. Each input device that is made of transparent material allows an image of a card displayed on the screen of the display device to be externally observable. The plurality of input devices is configured to output independently of one another data related to a position in a coordinate system. The controller is configured to: (a) start a card game; (b) cause the display device to display a plurality of images of cards at specified positions in the coordinate system on a screen; and (c) cause the display device to display an image of a card corresponding to each of the plurality of input devices in a specified manner in response to reception of a signal indicating data related to a position in the coordinate system from each of the plurality of input devices.

This application is based on and claims the benefit of priority from Japanese Patent Application No. 2007-117330, filed on 26 Apr. 2007, the content of which is incorporated herein by reference.

### BACKGROUND OF THE INVENTION

1. Field of the Invention

The present invention relates to a gaming machine that uses a plurality of touch panels as an input device.

2. Related Art

Conventionally, an input device of a gaming machine is put into classified categories of push button, keyboard, and touch panel. However, a push button has limited functions of turning-on and turning-off, whereby the number of buttons tends to increase as a game becomes more complicated. In this way, the buttons occupy a large part of the operation space of a gaming machine. This situation may adversely affect the intuitiveness of operation performed by a player, thereby possibly inducing her to have a feeling to avoid the game. Furthermore, although personal computers have gained widespread acceptance, the level of proficiency differs greatly in individuals, and keyboards have problems of durability, because keyboards themselves may be easily damaged. In order to solve the abovementioned problems, a touch panel is used as an input device of a gaming machine. U.S. Pat. No. 6,729,618 discloses a gaming machine including a touch panel as an input device, which allows a player to advance a game by directly touching the touch panel superimposed on a display. Furthermore, U.S. Patent Application Publication No. 2005/0090304 discloses a gaming machine which displays card images turned over while a player is rubbing a touch panel superimposed on the card images displayed on the display.

However, in regards to such touch panels, usually a single panel is used for a single display as a set. Thus, when a touch panel has a fault, such as a detection error as a result of a rubbing action repeated to change a display of a card image on the display, the entire touch panel is required to be replaced, because a damaged portion of the touch panel cannot be partially replaced. Furthermore, in order to detect the rubbing action, it is necessary to detect a distance and a direction associated with movement of positions in a coordinate system that correspond to points touched by a player on the touch panel. When such a technique is applied to a plurality of card images, simultaneous detection of positions in a coordinate system is required for a plurality of locations on the touch panel. Therefore, this causes much load on control of the touch panel while the detailed movement of the positions in the coordinate system is being detected so as to control turning over for a card image.

### SUMMARY OF THE INVENTION

The present invention has an object of providing a gaming machine which can further improve entertainment properties thereof.

Furthermore, the present invention has an object of providing a gaming machine including a plurality of touch panels arranged separately on a display, whereby a touch panel can be replaced easily and the load caused by detection can be alleviated.

In an aspect of the present invention, a gaming machine is provided, which includes a display device, a plurality of input devices, and a controller. The display device displays a plurality of images of cards at specified positions in a coordinate system on a screen. Each of the plurality of input devices detects a touch action performed by a player and outputs data related to a position in the coordinate system corresponding to a position touched by the player. In addition, each of the plurality of input devices is disposed on a front side of the display device as viewed by the player and is disposed so as to cover a whole image of a card that is displayed at a specified position in the coordinate system on the screen of the display device. Furthermore, each of the plurality of input devices that is made of transparent material allows an image of a card displayed on the screen of the display device to be externally observable. The plurality of input devices is configured to output independently of one another the data related to the position in the coordinate system. In addition, the controller is configured to: (a) start a card game; (b) cause the display device to display the plurality of images of cards at the specified positions in the coordinate system on the screen; and (c) cause the display device to display an image of a card corresponding to each of the plurality of input devices in a specified manner in response to reception of a signal indicating data related to a position in the coordinate system from each of the plurality of input devices.

The gaming machine described above, which includes the plurality of input devices, can restrict replacement of the input devices to those that have defects caused by repeated rubbing operation.

In addition, since the plurality of input devices is configured to output independently of one another the data related to the position in the coordinate system, the gaming machine can alleviate load, which is imposed on the controller while detecting a distance of movement and a direction of movement associated with movement of the position touched by the player so as to detect rubbing operation.

With the advantages described above, the gaming machine of the present invention allows the player to have a chance to enjoy a more entertaining game.

In another aspect of the present invention, a gaming machine is provided, which includes a display device, a plurality of input devices, and a controller. The display device displays a plurality of images of cards at specified positions in a coordinate system on a screen. Each of the plurality of input devices detects a touch action performed by a player and outputs data related to a position in the coordinate system corresponding to a position touched by the player. In addition, each of the plurality of input devices is disposed on a front side of the display device as viewed by the player and disposed so as to cover a whole image of a card that is displayed at a specified position in the coordinate system on the screen of the display device. Furthermore, each of the plurality of input devices that is made of transparent material allows an image of a card displayed on the screen of the display device to be externally observable. The plurality of input devices is configured to output independently of one another the data related to the position in the coordinate system. In addition, the controller is configured to: (a) start a card game; (b) cause the display device to display the plurality of images of cards at the specified positions in the coordinate system on the screen; (c) receive the data related to the position in the coordinate system from each of the plurality of input devices; and (d) cause the display device to display an image of a card corresponding to each of the plurality of input devices in a manner in accordance with a locus defined by the received data related to the position in the coordinate system.

Since the gaming machine described above allows the player to see a card turning over in a form of image, she can experience a realistic feeling of manipulation while playing a card game.

In still another aspect of the present invention, a gaming machine is provided, which includes a display device, a plurality of input devices, and a controller. The display device displays a plurality of images of cards at specified positions in a coordinate system on a screen. Each of the plurality of input devices detects a touch action performed by a player and outputs data related to a position in the coordinate system corresponding to a position touched by the player. In addition, each of the plurality of input devices is disposed on a front side of the display device as viewed by the player and disposed so as to cover a whole image of a card that is displayed at a specified position in the coordinate system on the screen of the display device. Furthermore, each of the plurality of input devices that is made of transparent material allows an image of a card displayed on the screen of the display device to be externally observable. The plurality of input devices is configured to output independently of one another the data related to the position in the coordinate system. In addition, the controller is configured to: (a) start a card game; (b) cause the display device to display the plurality of images of cards at the specified positions in the coordinate system on the screen; (c) receive the data related to the position in the coordinate system from each of the plurality of input devices; and (d) cause the display device to display an image of a card corresponding to each of the plurality of input devices in a variable manner of a pattern in accordance with a locus defined by the received data related to the position in the coordinate system.

According to the present invention, by arranging a plurality of touch panels separately on a display, the touch panels can be replaced easily and the load caused by detection can be alleviated.

Furthermore, the present invention provides a gaming machine with new entertainment properties.

### BRIEF DESCRIPTION OF THE DRAWINGS

FIG. 1 is a flowchart showing the flow of a game which is executed in a gaming machine according to the preferred embodiment of the present invention;

FIG. 2 is an external perspective view showing the gaming machine according to the preferred embodiment of the present invention;

FIG. 3 is a front view showing an enlarged view of a display region of the gaming machine according to the preferred embodiment of the present invention;

FIG. 4 is a perspective view showing the arrangement of a liquid crystal display, touch panel and covering of the gaming machine according to a preferred embodiment of the present invention;

FIG. 5 is a block diagram showing a controller of the gaming machine according to a preferred embodiment of the present invention;

FIG. 6 is a block diagram showing a display/input controller of the gaming machine according to a preferred embodiment of the present invention;

FIG. 7 is a flowchart showing a flow for game processing executed by the gaming machine according to a preferred embodiment of the present invention;

FIG. 8 is a diagram showing the geometrical relation of a plurality of touch panels placed on the liquid crystal display using a two-dimensional coordinate system according to a preferred embodiment of the present invention;

FIG. 9 is an example of a display image according to a preferred embodiment of the present invention;

FIG. 10 is an example of a display image according to a preferred embodiment of the present invention;

FIG. 11 is a diagram showing an example of a starting point and an ending point, according to a preferred embodiment of the present invention;

FIG. 12 is an example of a display image according to a preferred embodiment of the present invention;

FIG. 13 is a diagram showing an example of a starting point and an ending point, according to a preferred embodiment of the present invention; and

FIG. 14 is an example of a display image according to a preferred embodiment of the present invention.

### DETAILED DESCRIPTION OF THE INVENTION

Embodiments of the present invention are hereinafter described in detail with reference to the attached drawings.

A gaming machine 13 according to the present invention includes: a liquid crystal display 30 that displays a plurality of card images at predetermined positions in a coordinate system, and a plurality of touch panels 80A to 80E that outputs coordinate data indicating positions in the coordinate system corresponding to touched positions. The plurality of touch panels 80A to 80E is arranged as viewed from a player on the front surface of a liquid crystal display 30 so as to completely cover a plurality of card images displayed at predetermined positions in the coordinate system on the liquid crystal display 30. The touch panels 80A to 80E are made of transparent material, whereby card images displayed on the liquid crystal display 30 are visible from outside via the touch panels, and are configured to output the coordinate data independently from each other. Each of the touch panels 80A to 80E is arranged so as to cover a whole card image. Specifically, a CPU 106 starts a card game, displays a plurality of card images at predetermined positions in the coordinate system on the liquid crystal display 30 in response to starting of the card game. In addition, the CPU 106 displays card images corresponding to the touch panels 80A to 80E in a predetermined manner in response to receiving coordinate data from each of the touch panels 80A to 80E.

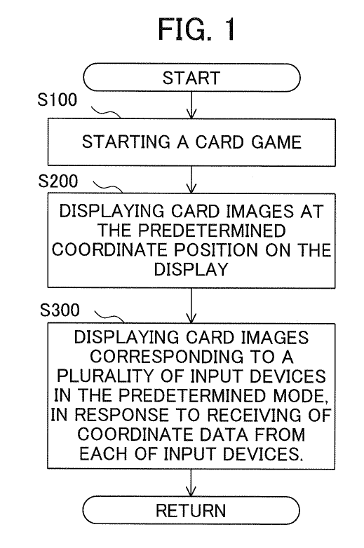

Specifically, although the details are described later, as shown in FIG. 1, the CPU 106 starts a card game (Step S100), displays a plurality of card images at the predetermined positions in the coordinate system on the liquid crystal display 30 in response to starting of the card game (Step S200), and displays the card images corresponding to input devices in the predetermined manner in response to reception of coordinate data from each of the plurality of input devices (for example, touch panels 80A to 80E and the like) (Step S300).

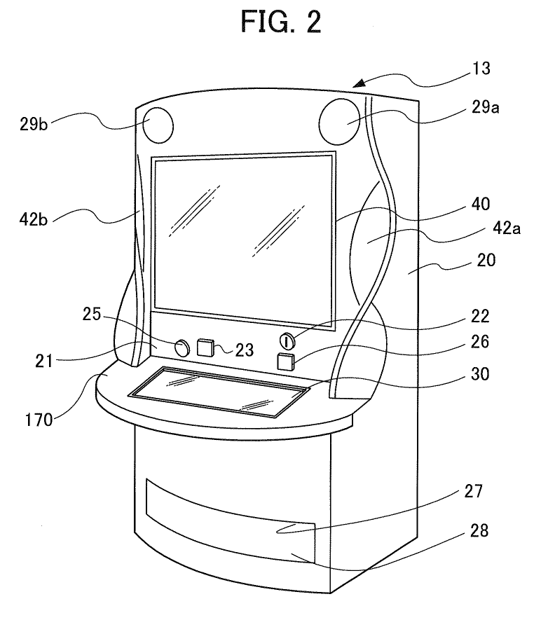

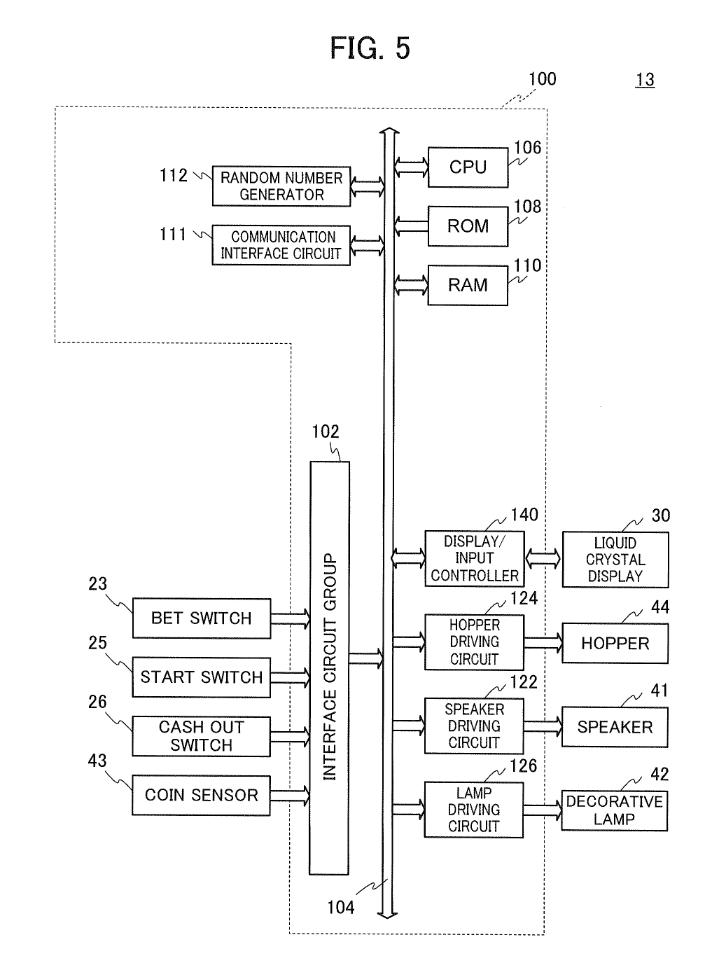

FIG. 2 is a perspective view showing the gaming machine 13 according to an embodiment of the present invention. The gaming machine 13 includes a cabinet 20. The cabinet 20 has a surface opening towards a player. The cabinet 20 contains various components including a game controller 100 (refer to FIG. 5) for electrically controlling the gaming machine 13, and a hopper 44 (refer to FIG. 5) for controlling the insertion, storage, and payout of coins (as a game medium), and the like. The game medium is not limited to coins. In addition, examples of such game medium include medals, tokens, electronic money, and electronic value information (credit) having the same value.

A liquid crystal display 40 is provided at substantially the center of the front face of the cabinet 20. A first operation unit 21, which is substantially vertical, is provided below the liquid crystal display 40. The first operation unit 21 includes a coin insertion slot 22, a bet switch 23, a start switch 25, and a cash out switch 26. The coin insertion slot 22, thorough which a coin is inserted into the gaming machine 13, is provided on the right side of the first operation unit 21.

The bet switch 23 is provided on the left side of the first operation unit 21. The bet switch 23 allows a player to select the amount of coins to bet for a combination of cards, which a player expects as an outcome in a porker game. The amount of coins to bet for the combination of cards expected to be formed in the poker game is determined by pressing operation of the bet switch 23.

The start switch 25 is provided on the left side of the bet switch 23 which is provided on the left side of the first operation unit 21. The start switch 25 triggers the game to start by accepting the starting operation by the player for each poker game. Upon pressing operation of the start switch 25, the CPU 106, which is described later, reads a game program from ROM 108, and the poker game starts.

A cash out switch 26 is disposed in the vicinity of the coin insertion slot 22 so as to pay out coins. Specifically, upon the pressing operation of cash out switch 26 by the player, the inserted coins are paid out from a coin payout opening 27 provided at a lower portion of the front face of the cabinet 20, and coins thus paid out are retained in a coin tray 28.

A second operation unit 170, which is substantially horizontal, is provided below the first operation unit 21. The second operation unit 170 includes a liquid crystal display 30.

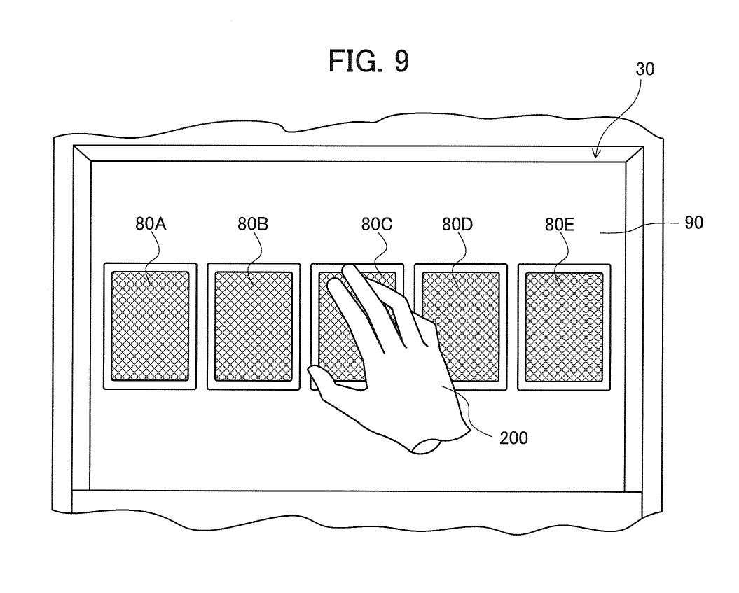

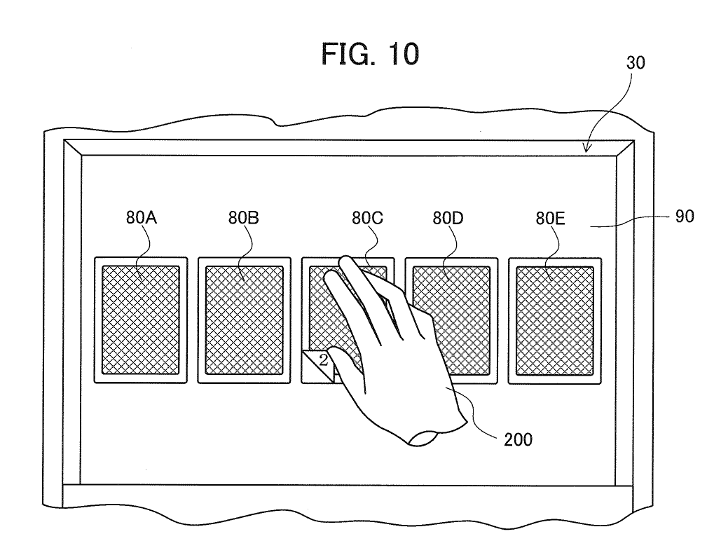

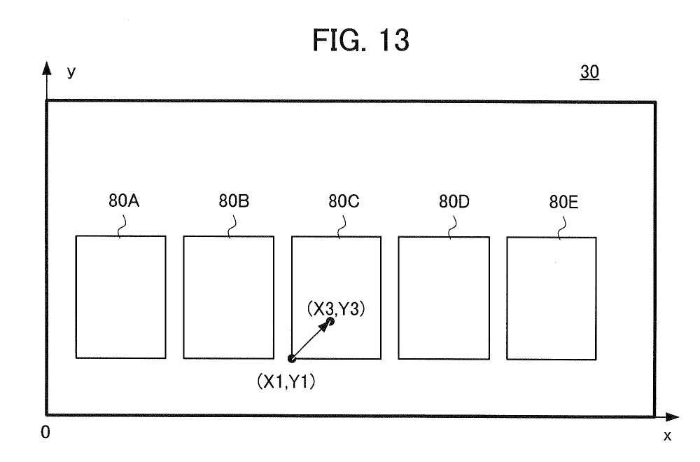

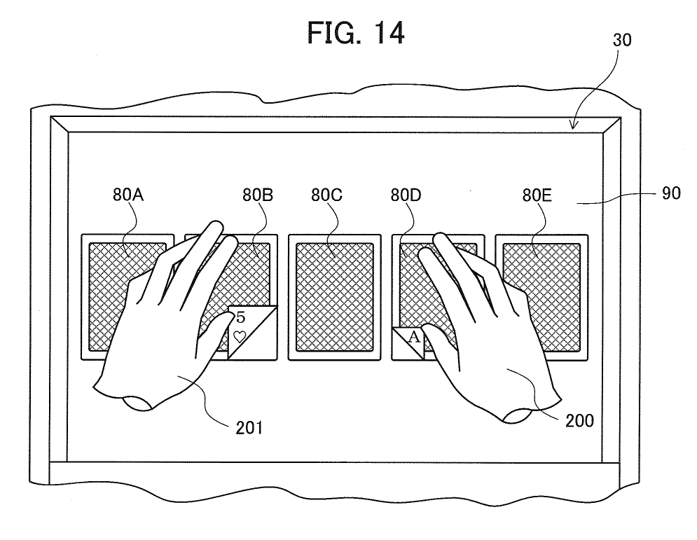

The liquid crystal display 30 realizes a display device for displaying a variety of images related to the game including rendered images and the like. The player advances the game while observing the variety of images displayed on the liquid crystal display 30. In such games, the liquid crystal display 30 displays images of poker games as shown in FIG. 9, FIG. 10, FIG. 13 and FIG. 14, which are described later.

The liquid crystal display 40 distinguishing from the liquid crystal display 30 is a display serves as a sub display for displaying game rules, demonstration images, and the like.

Furthermore, sound transmission openings 29a and 29b are provided on both upper left and right sides of the liquid crystal display 40. Here, the sound transmission openings 29a and 29b are provided for transmitting sound effects generated by a speaker 41 (refer to FIG. 5) installed within the cabinet 20. The sound transmission openings 29a and 29b generate sound effects and the like in accordance with the progress of the game. Decorative lamps 42a and 42b are provided on both right and left sides of substantially the center of the gaming machine 13. The decorative lamps 42a and 42b emit light in accordance with the progress of the game.

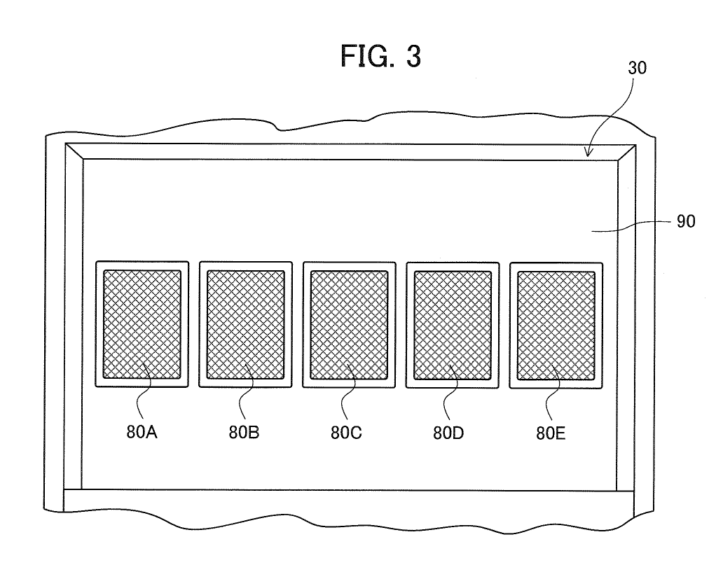

FIG. 3 is an enlarged view showing the display area of the liquid crystal display 30 of the gaming machine 13. An opaque covering portion 90, which makes an image invisible to a player, is arranged on the liquid crystal display 30. The touch panels 80A to 80E are arranged on the liquid crystal display 30 where the covering portion 90 is not provided. The touch panels 80A to 80E are composed of a light permeable material (transparent material). The player can visually recognize the images displayed on the liquid crystal display 30 via the touch panels 80A to 80E. In the present embodiment, each of the touch panels 80A to 80E is arranged so as to cover a whole card image. Furthermore, since the covering portion 90 is composed of a material which does not detect touching by a player, the covering portion 90 does not read coordinate data associated with touching by the player as the touch panel does.

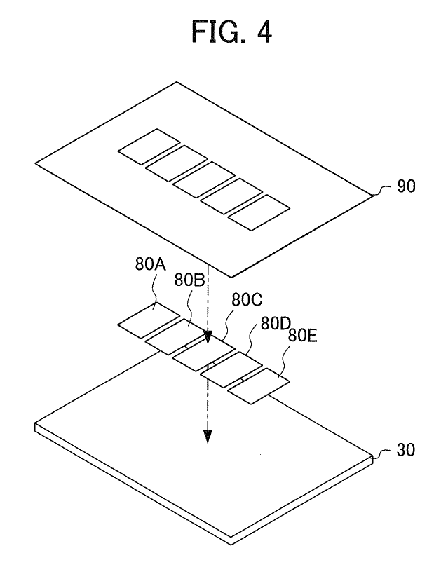

FIG. 4 is a perspective view showing a relation among the liquid crystal display 30, the touch panels 80A to 80E and the covering portion 90. According to FIG. 4, the opaque covering portion 90, which makes the image invisible to a player, is arranged on the liquid crystal display 30. The touch panels 80A to 80E are arranged on the liquid crystal display 30 where the covering portion 90 is not provided. When a player simultaneously touches the touch panels 80A and 80C, which are independent from each other, the touch panels 80A and 80C independently transmit the coordinate data indicating a touching position to the CPU 106 (refer to FIG. 5).

FIG. 5 is a block diagram showing the electrical configuration of a game controller 100 of the gaming machine 13. As shown in FIG. 5, the game controller 100 of the gaming machine 13 is a microcomputer which includes an interface circuit group 102, an input/output bus 104, CPU 106, ROM 108, RAM 110, a communication interface circuit 111, a random number generator 112, a speaker drive circuit 122, a hopper drive circuit 124, a lamp drive circuit 126, and a display/input controller 140.

The interface circuit group 102 is electrically connected with the input/output bus 104, which carries out the input and output of data signals or address signals for the CPU 106.

The start switch 25 is electrically connected with the interface circuit group 102. In the interface circuit group 102, a start signal generated by the start switch 25 is converted into a predetermined signal to be supplied to the input/output bus 104.

The bet switch 23 and the cash out switch 26 are also electrically connected to the interface circuit group 102. Each of the switching signals output from these switches 23 and 26 is also supplied to the interface circuit group 102, and is converted into a predetermined signal by the interface circuit group 102 to be supplied to the input/output bus 104.

A coin sensor 43 is also electrically connected with the interface circuit group 102. The coin sensor 43 is a sensor for detecting coins inserted into the coin insertion slot 22, and disposed in association with the coin insertion slot 22. A sensing signal output from the coin sensor 43 is also supplied to the interface circuit group 102, and is converted into a predetermined signal by the interface circuit group 102 to be supplied to the input/output bus 104.

The ROM 108 and the RAM 110 are connected to the input/output bus 104.

Upon acceptance of the start operation of a game through the start switch 25, the CPU 106 reads a game program for a poker game and executes the poker game.

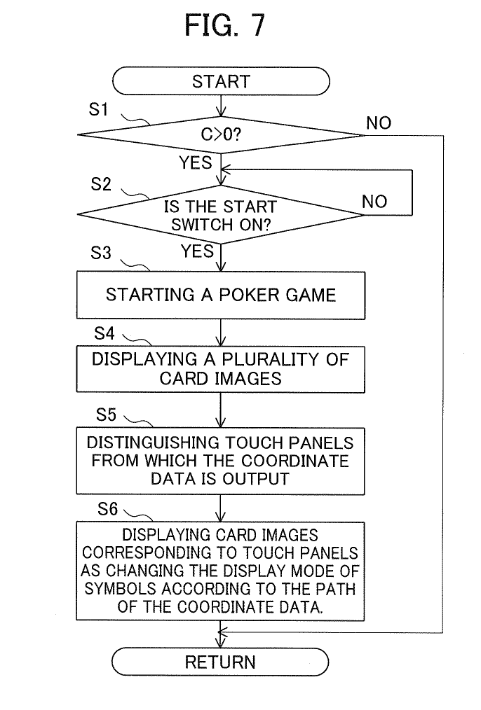

The ROM 108 stores: a control program for central control of the slot machine 13; a program for executing a routine shown in FIG. 7 (which is referred to as the “routine execution program” hereafter); initial data for executing the control program; and various data tables used for determination processing. The routine execution program includes the abovementioned game program. The RAM 110 temporarily stores flags, variables and the like used for the control program.

The communication interface circuit 111 is also connected to the input/output bus 104. The communication interface circuit 111 is a circuit for communicating with a central controller 11 and the like via a network 12 including a variety of networks of LAN.

The random number generator 112 for generating a random number is also connected to the input/output bus 104. The random number generator 112 generates random numbers lying in a predetermined range of 0 to 65535 (the sixteenth power of two minus one), for example. Alternatively, a random number may be generated by computation performed by the CPU 106.

The speaker driving circuit 122 for driving the speaker 41 is also connected to the input/output bus 104. The CPU 106 reads the sound data stored in the ROM 108, and transmits the sound data to the speaker driving circuit 122 via the input/output bus 104. This enables the speaker 41 to emit predetermined sound effects.

The hopper drive circuit 124 for driving the hopper 44 is also electrically connected to the input/output bus 104. Upon reception of a cash out signal input via the cash out switch 26, the CPU 106 transmits a driving signal to the hopper driving circuit 124 via the input/output bus 104. Accordingly, the hopper 44 pays out coins corresponding to the amount of the remained credits, which is stored in the predetermined memory area of the RAM 110.

Alternatively, the payout of the coins may be performed in a mode of storing credit data in a data card and the like, instead of using material coins. That is, the player may carry a card functioning as a recording medium, and store the data related to the credit by inserting the card into the gaming machine 13.

The lamp drive circuit 126 for driving the decorative lamps 42a and 42b is also connected to the input/output bus 104. The CPU 106 transmits the signal for driving the lamps to the lamp driving circuit 126 according to the predetermined conditions based on the program stored in the ROM 108. Thus, decorative lamps 42a and 42b blink and the like.

The display/input controller 140 is also connected to the input/output bus 104. The CPU 106 creates an image display command corresponding to the state and results of the game, and outputs the image display command thus created to the display/input controller 140 via the input/output bus 104. Upon reception of the image display command input from the CPU 106, the display/input controller 140 creates a driving signal for driving the liquid crystal display 30 according to the image display command thus input, and outputs the driving signal thus created to the liquid crystal display 30. This enables a predetermined image to be displayed on the liquid crystal display 30. The display/input controller 140 transmits the signal accepted via a touch panel 32 to the CPU 106 via the input/output bus 104 in a form of the input signal.

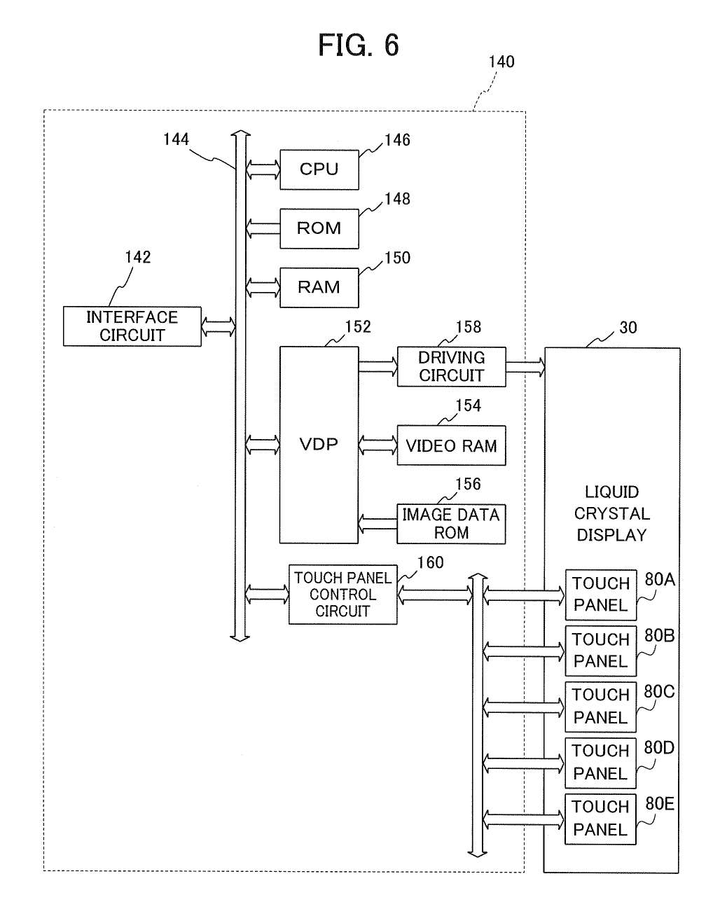

FIG. 6 is a block diagram showing the electrical configuration of the display/input controller 140 of the gaming machine 13. The display/input controller 140 of the gaming machine 13 is a sub-micro computer which performs image display processing and input control for the touch panel 30. The display/input controller 140 includes an interface circuit 142, an input-output bus 144, a CPU 146, a ROM 148, a RAM 150, a VDP 152, a video RAM 154, a ROM 156 for image data, a drive circuit 158, and a touch panel control circuit 160.

The interface circuit 142 is connected to the input/output bus 144. An image display instruction output from the CPU 106 on the abovementioned game controller 100 is supplied to the input/output bus 144 via the interface circuit 142. The input/output bus 144 performs input/output of data signals or address signals to and from the CPU 146.

The ROM 148 and the RAM 150 are connected to the input/output bus 144. The ROM 148 stores a display control program for generating the drive signal to be supplied to the liquid crystal display 30, based on the image display commands from the CPU 106 on the game controller 100. The RAM 150 stores flags and variables used in the display control program.

The VDP 152 is also connected to the input/output bus 144. The VDP 152 is a processing device for performing various kinds of processing for displaying images on the liquid crystal display 30, including a so-called sprite circuit, a screen circuit, a palette circuit, and the like. The video RAM 154 and the ROM 156 are connected to the VDP 152. The video RAM 154 stores image data in response to the image display commands from the CPU 106 on the game controller 100. The ROM 156 stores various kinds of image data including above mentioned rendered image data. Furthermore, the driving circuit 158 for outputting a driving signal for driving the liquid crystal display 30 is connected to the VDP 152.

The CPU 146 reads and executes the display control program stored in the ROM 148, whereby the video RAM 154 stores image data to be displayed on the liquid crystal display 30 in response to the image display commands from the CPU 106 on the game controller 100. The image display commands include various commands for displaying the abovementioned rendered image and the like.

The ROM 156 for image data stores various kinds of image data including the rendered image data and the like.

The touch panel control circuit 160 transmits input signals, which the touch panels 80A to 80E on the liquid crystal display 30 have respectively received, to the CPU 106 via the input/output bus 144. In addition, the touch panel control circuit 160 transmits the input signals independently from each other to the CPU 106 via the input/output bus 144. For example, when a player simultaneously touches the touch panels 80A and 80C, the touch panel control circuit 160 independently transmits input signals that have been output by the touch panels 80A and 80C to the CPU 106 in a form of separate signals.

FIG. 7 is a flowchart showing a flow of the processing operation of the gaming machine 13, which is executed by the game controller 100 of the gaming machine 13. The processing operation is called to execute at predetermined timing from a main program of the gaming machine 13, which is executed in advance.

In the following, it is supposed that the gaming machine 13 is activated in advance and the variables used in the CPU 106 on the game controller 100 are initialized to predetermined values, whereby the gaming machine 13 is operated in a normal state.

First, the CPU 106 on the game controller 100 determines whether or not there remains a certain amount of credits which corresponds to a remaining amount of coins inserted by a player (Step S1). Specifically, the CPU 106 reads a credit amount C stored in the RAM 110, and executes processing according to the credit amount C. In a case where the credit amount C is “0” (NO in Step S1), the CPU 106 terminates the routine without executing any processing, since a game cannot be started. On the other hand, in a case where the credit amount C is not less than “1” (YES in Step S1), the CPU 106 determines that a credit remains, and the CPU 106 moves the processing to Step S2.

In Step S2, the CPU 106 determines whether or not the start switch 25 has been activated, and then waits for the start switch 25 to be operated. Upon the start switch 25 being activated, and accordingly, upon the operation signal being input from the start switch 25 (YES in Step S2), the CPU 106 determines that the start switch 25 has been operated, and the CPU 106 moves the processing to Step S3.

In Step S3, the CPU 106 starts the poker game. Specifically, the CPU 106 extracts the image data of a screen (not shown) for stating the poker game from the ROM 156 for image data via display/input controller 140, and displays the image on the liquid crystal display 30. Subsequently, the CPU 106 moves the processing to Step S4.

In Step 4, the CPU 106 displays a plurality of card images. Specifically, the CPU 106 displays the plurality of card images so as to allow the player to visually recognize via touch panels 80A to 80E placed on the liquid crystal display 30 (refer to FIG. 9). Subsequently, the CPU 106 moves the processing to Step S5.

In Step S5, the CPU 106 identifies touch panels from which the CPU 106 has received coordinate data. Specifically, the CPU 106 distinguishes the touch panels 80A to 80E so as to identify touch panels from which the CPU 106 has received coordinate data upon receiving the coordinate data via the display/input controller 140. The CPU 106 then moves the processing to Step S6.

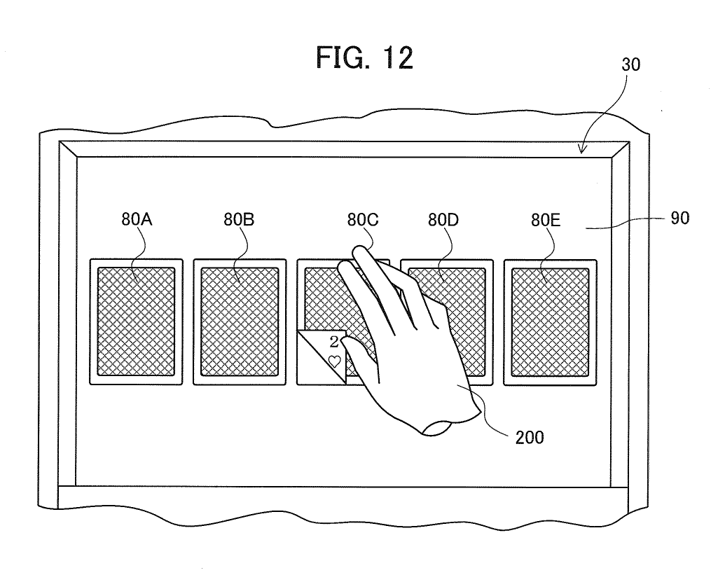

In Step S6, the CPU 106 displays a card image corresponding to each touch panel, while changing a display manner of a symbol according to the locus defined by the coordinate data. Specifically, detecting the coordinate data at predetermined time intervals, the CPU 106 calculates a distance of movement and a direction of movement between an initial position and a current position touched by the player on the touch panels 80A to 80E. According to the distance of movement and the direction of movement, the CPU 106 displays card images corresponding to the touch panels 80A to 80E, changing display manners of symbols. Subsequently, the CPU 106 terminates the routine. It should be noted that a specific example of the display mode is described later with reference to FIG. 9, FIG. 10, FIG. 12, and FIG. 14.

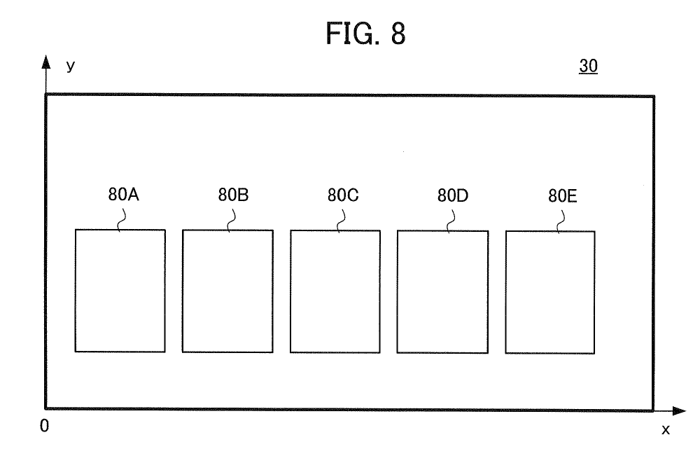

FIG. 8 is a diagram illustrating the geometrical relation of the touch panels 80A to 80E arranged on the liquid crystal display 30, using a two-dimensional coordinate system with an X-axis and a Y-axis. In FIG. 8, on the liquid crystal display 30, the touch panels 80A to 80E are each arranged in series in order of 80A through 80E from the left hand side of the player. More specifically, positions of center of gravity are arranged among the touch panels 80A to 80E with respect to the X-axis in the order of smaller to larger value as follows: the touch panels 80A, 80B, 80C, 80D, and 80E. Furthermore, values of the Y-axis for the center of gravity of the respective touch panels 80A to 80E are the same. Moreover, the touch panels 80A to 80E are arranged so as not to be overlapped with each other.

FIG. 9 is a diagram showing an example of a rendered image. In FIG. 9, a plurality of trump card images placed face down is displayed via the touch panels 80A to 80E on the liquid crystal display 30. Furthermore, the thumb of a player's right hand 200 is in contact with the touch panel 80C. Moreover, the player's right hand 200 is covering up an image of a trump card corresponding to the touch panel 80C.

FIG. 10 is a diagram showing an example of a rendered image. In FIG. 10, an image of the trump card corresponding to the touch panel 80C with one portion thereof being turned over is displayed on the liquid crystal display 30. Furthermore, the player's right hand 200 is covering up the image of the trump card corresponding to the touch panel 80C. When the thumb of the player's right hand 200 rubs the touch panel 80C, the one portion of the image of the trump card to be turned over is determined according to the distance of movement and the direction of movement of the position touched by the thumb.

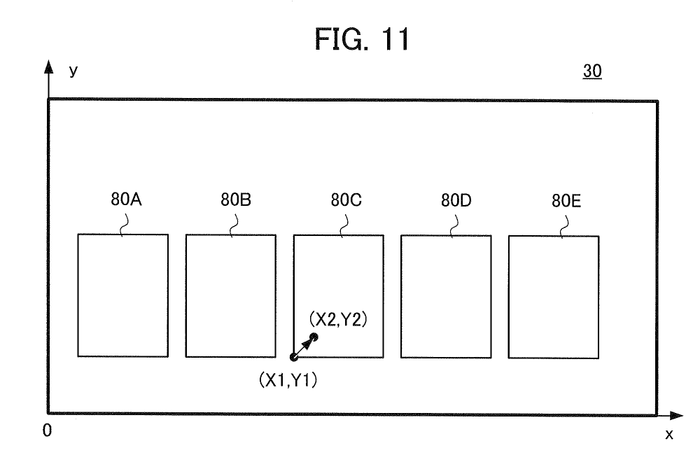

For example, as shown in FIG. 11, suppose that a position in the coordinate system is (X1, Y1), at which the thumb of the player's right hand 200 has started touching the touch panel 80C, and a position in the coordinate system is (X2, Y2), at which the thumb of the player's right hand 200 is currently touching the touch panel 80C. One portion of the image of the trump card to be turned over is determined based on vector data including (X1, Y1) as a starting point and (X2, Y2) as an ending point. Here, referring to FIG. 10 again, the thumb of the player's right hand 200 rubs the front left side of the touch panel 80C, whereby a numbered portion “2” of the trump card is shown.

As shown in FIG. 10, the player can visually confirm the numbered portion of the trump card while covering up another portion of the image of the trump card with the player's right hand 200. Thus, the player can prevent a symbol printed on the trump card from being disclosed to other players. In addition, such configuration enables the player to experience realistic operation.

FIG. 12 is a diagram showing an example of a rendered image. In FIG. 12, an image of the trump card corresponding to the touch panel 80C is displayed on the liquid crystal display 30 with one portion turned over. The player's right hand 200 is covering up the image of the trump card corresponding to the touch panel 80C. When the thumb of the player's right hand 200 rubs the touch panel 80C, a portion of the image of the trump card to be turned over is determined according to the distance of movement and the direction of movement of a position touched by the thumb.

For example, as shown in FIG. 13, suppose that a position in the coordinate system is (X1, Y1), at which the thumb of a player's right hand 200 has started to touch the touch panel 80C, and a position in the coordinate system is (X3, Y3), at which the thumb of the player's right hand 200 is currently touching the touch panel 80C. A portion of the trump card image to be turned over is determined based on vector data including (X1, Y1) as a starting point and (X3, Y3) as an ending point. Here, referring to FIG. 12 again, the thumb of the player's right hand 200 rubs the front left side of the touch panel 80C, whereby a numbered portion “2” and a suit portion “hearts” of the trump card are shown.

As shown in FIG. 12, the player can visually confirm the numbered portion and the suit portion of the trump card while covering up a portion of an image of the trump card by the player's right hand 200. Thus, the player can prevent a symbol printed on the trump card from being disclosed to other players. In addition, such a configuration enables the player to experience realistic operation.

FIG. 14 is a diagram showing an example of a rendered image. In FIG. 14, images of trump cards corresponding to the touch panels 80B and 80D are displayed on the liquid crystal display 30 with one portion turned over. The player's right hand 200 and left hand 201 are covering up the images of trump cards corresponding to the touch panels 80B and 80D. When the thumbs of the player's right hand 200 and left hand 201 rub the touch panels 80B and 80D, respectively, a portion of each trump card to be turned over is determined according to the distance of movement and the direction of movement of a position touched by a thumb. In FIG. 14, the thumb of the player's right hand 200 rubs the front left side of the touch panel 80D, whereby a numbered portion “A” of the trump card is shown. On the other hand, the thumb of the player's left hand 201 rubs the front right side of the touch panel 80B, whereby a numbered portion “5” and a suit portion “hearts” of the trump card are shown.

As shown in FIG. 14, the player can visually confirm only the numbered portion, and both the numbered portion and the suit portion of the trump card while partially covering up the images of the trump cards by the player's right hand 200 and the left hand 201. Thus, the player can prevent symbols printed on the trump card from being disclosed to other players. In addition, such a configuration allows the player to experience realistic operation.

In the present embodiment, although the player can turn over one portion of the image of a card by rubbing each of the touch panels 80A, 80B, 80C, 80D, and 80E with the player's right hand 200 or left hand 201, it is not limited thereto. Alternatively, an entire portion of the image of the card may be moved by rubbing each of the touch panels 80A, 80B, 80C, 80D, and 80E. Furthermore, one portion of the image of the card may be turned over by touching in place of rubbing. In this case, the portion of the image of the card corresponding to where the player has touched is turned over.

Moreover, in the present embodiment, although the portion of the image of the card to be turned over is determined based on the distance of movement and the direction of movement between a present position and a position where the player has started to touch, it is not limited thereto. Alternatively, the portion of the image of the card to be turned over may be determined by only the direction of movement of the touched position.

In addition, five touch panels are used in the present embodiment, but it is not limited thereto. Alternatively, touch panels of more than five and touch panels of less than five may be used.

In the present embodiment, the description is made in relation to the poker game; however, the present embodiment is not limited thereto. Alternatively, the present embodiment may include other card games such as baccarat, blackjack and the like.

While the embodiments according to the present invention have been described as mentioned above, it is understood that many changes and modifications may be made therein without departing from the spirit and scope of the present invention.

What is claimed is:

1. A gaming machine, comprising:
a display device for displaying a plurality of images of cards at specified positions in a coordinate system on a screen;
a plurality of input devices, each detecting a touch action performed by a player, each outputting data related to a position in the coordinate system corresponding to a position touched by the player, each being disposed on a front side of the display device as viewed by the player, and each being disposed so as to cover a whole image of a card that is displayed at a specified position in the coordinate system on the screen of the display device,
wherein each of the plurality of input devices that is made of transparent material allows an image of a card displayed on the screen of the display device to be externally observable, and the plurality of input devices is configured to output independently of one another the data related to the position in the coordinate system; and
a controller configured to:
(a) start a card game;
(b) cause the display device to display the plurality of images of cards at the specified positions in the coordinate system on the screen; and
(c) cause the display device to display an image of a card corresponding to each of the plurality of input devices in a specified manner in response to reception of a signal indicating data related to a position in the coordinate system from each of the plurality of input devices.

2. A gaming machine, comprising:
a display device for displaying a plurality of images of cards at specified positions in a coordinate system on a screen;
a plurality of input devices, each detecting a touch action performed by a player, each outputting data related to a position in the coordinate system corresponding to a position touched by the player, each being disposed on a front side of the display device as viewed by the player, and each being disposed so as to cover a whole image of a card that is displayed at a specified position in the coordinate system on the screen of the display device,
wherein each of the plurality of input devices that is made of transparent material allows an image of a card displayed on the screen of the display device to be externally observable, and the plurality of input devices is configured to output independently of one another the data related to the position in the coordinate system; and
a controller configured to:
(a) start a card game;
(b) cause the display device to display the plurality of images of cards at the specified positions in the coordinate system on the screen;
(c) receive the data related to the position in the coordinate system from each of the plurality of input devices; and
(d) cause the display device to display an image of a card corresponding to each of the plurality of input devices in a manner in accordance with a locus defined by the received data related to the position in the coordinate system.

3. A gaming machine, comprising:
a display device for displaying a plurality of images of cards at specified positions in a coordinate system on a screen;
a plurality of input devices, each detecting a touch action performed by a player, each outputting data related to a position in the coordinate system corresponding to a position touched by the player, each being disposed on a front side of the display device as viewed by the player, and each being disposed so as to cover a whole image of a card that is displayed at a specified position in the coordinate system on the screen of the display device,
wherein each of the plurality of input devices that is made of transparent material allows an image of a card displayed on the screen of the display device to be externally observable, and the plurality of input devices is configured to output independently of one another the data related to the position in the coordinate system; and
a controller configured to:
(a) start a card game;
(b) cause the display device to display the plurality of images of cards at the specified positions in the coordinate system on the screen;
(c) receive the data related to the position in the coordinate system from each of the plurality of input devices; and
(d) cause the display device to display an image of a card corresponding to each of the plurality of input devices in a variable manner of a pattern in accordance with a locus defined by the received data related to the position in the coordinate system.
